(19) United States
(12) Patent Application Publication
(10) Pub. No.: US 2014/0142788 A1
(43) Pub. Date: May 22, 2014

(54) SYSTEM AND METHOD FOR PROVIDING ACCURACY IN AIRDROP MISSIONS

(71) Applicant: UNITED STATES AIR FORCE, Rome, NY (US)

(72) Inventor: ROBERT J. DENTON, ROME, NY (US)

(21) Appl. No.: 14/040,816

(22) Filed: Sep. 30, 2013

Related U.S. Application Data
(60) Provisional application No. 61/797,089, filed on Nov. 16, 2012.

(51) Int. Cl. B64C 19/00; G01W 1/00

(52) U.S. Cl. CPC B64C 19/00; G01W 1/00
USPC 701/3; 702/3

(57) ABSTRACT

System and method for aiding the accuracy of airdrop missions by performing localized weather data collection in a column of air and then subsequently storing, decimating and forwarding the data to a remote location. A first aircraft flies to the geographic location of the desired airdrop, deploys an atmospheric conditions sensing dropsonde, collects the data from the dropsonde, stores that data, then transmits that data or a decimated subset of that data either once or any number of consecutive times, to a second aircraft located at a predetermined distance from the first aircraft.

PRIORITY CLAIM UNDER 35 U.S.C. §119(e)

This patent application claims the priority benefit of the filing date of provisional application Ser. No. 61/797,089, having been filed in the United States Patent and Trademark Office on Nov. 16, 2012 and now incorporated by reference herein.

### STATEMENT OF GOVERNMENT INTEREST

The invention described herein may be manufactured and used by or for the Government for governmental purposes without the payment of any royalty thereon.

### BACKGROUND OF THE INVENTION

This invention relates generally to remote collection of atmospheric data, and, more specifically, to the use of a remotely piloted aircraft to deploy an atmospheric parameter sensing windsonde, and even more specifically, to the method used to receive, process and store the data collected from the windsonde.

Atmospheric sensing windsondes have been traditionally deployed by the use of a helium filled weather balloon, released from a ground station, where they sense atmospheric conditions and transmit the data to a nearby ground receiving station as they ascend, or by a ground system that tracks the movement of the sonde as it ascends and thus are able to compute the wind direction and speed at a given altitude. There are some areas where it is desirable to ascertain the atmospheric conditions, but is impractical to launch a balloon based windsonde for various reasons, such as political, geographic or time sensitive issues. For those scenarios, one possible solution is to fly an aircraft over the area and release a sonde with a parachute attached and have a receiver aboard the aircraft collect the data as the sonde (or “dropsonde”) descends through the atmospheric column.

In U.S. Pat. Application #20090326792A1 filed by McGrath, a system is described that launches a windsonde from Predator (name brand) RPV, but the data collected by the system is intended for the use of the aircraft that the sonde was launched from in order to ascertain current conditions relating to flight of the host aircraft. There is no provision to store, decimate, or retransmit the collected data, or to use that data for any purpose other than to help determine optimum operational parameters of the host aircraft.

### OBJECTS AND SUMMARY OF THE INVENTION It is therefore an object of the present invention to provide an apparatus that overcomes the prior art's shortfalls and provide a system that will deploy a dropsonde from a remotely piloted aircraft in order to collect atmospheric wind conditions over a specific area and transmit that data to a distant location, specifically in this case to an airdrop aircraft at a specified distance to a drop area.

It is yet still a further object of the present invention to provide a means to decimate the data transmitted in such a manner as to allow the complete transmission of the dataset in 25% or less time than the original collection of data required.

It is yet still a further object of the present invention to provide a means to continuously retransmit the data in a loop until the device is commanded to stop the retransmission of the data.

Briefly stated, the present invention provides a system and method for aiding the accuracy of airdrop missions by performing localized weather data collection in a column of air and then subsequently storing, decimating and forwarding the data to a remote location. A first aircraft flies to the geographic location of the desired airdrop, deploys an atmospheric conditions sensing dropsonde, collects the data from the dropsonde, stores that data, then transmits that data or a decimated subset of that data either once or any number of consecutive times, to a second aircraft located at a predetermined distance from the first aircraft. The present invention achieves these and other objects through an innovative approach specifically to the method of storing, decimation processing, and retransmission control of the data.

The above and other objects, features and advantages of the present invention will become apparent from the following description read in conjunction with the accompanying drawings, in which like reference numerals designate the same elements.

### BRIEF DESCRIPTION OF THE DRAWINGS

FIG. 1 depicts the communication between a dropsonde, a dropsonde aircraft, and a cargo aircraft in the present invention.

FIG. 2 depicts the process steps performed by the present invention.

### DETAILED DESCRIPTION OF THE PREFERRED EMBODIMENT

This description and the accompanying drawing illustrate specific embodiments in which the present invention can be practiced, in enough detail to allow those skilled in the art to understand and practice the invention. Other embodiments, including logical, electrical, and mechanical variations, are within the skill of the art. Other advantages and features of the invention not explicitly described will also appear to those in the art. The scope of the invention is to be defined only by the appended claims, and not by the specific embodiments described below.

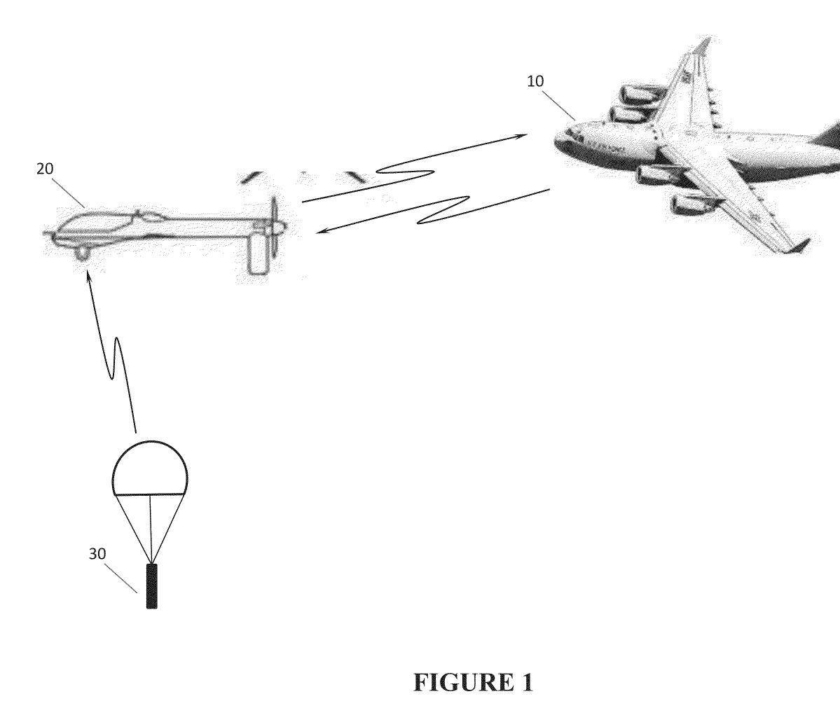

Referring to FIG. 1, the present invention is a system comprising a Tactical

Meteorological System incorporated into a pod (TMS Pod) intended to be mounted upon an M-299 modified Hellfire Launcher rail affixed to a manned military aircraft or an unmanned Remotely Piloted Aircraft (RPA) 20. A dropsonde 30 acquires meteorological and geolocation data during its descent, following ejection from the RPA 20 mounted TMS pod. The dropsonde transmits the data collected to the RPA 20. The RPA processes the data as necessary and forwards the data to an inbound cargo aircraft 10. Knowing up-to-date meteorological data at the exact drop site allows for precision cargo airdrop.

The TMS Pod, consists of a housing (the pod) containing within, a high-power transceiver and a command and control unit (CCU). Also mounted within, and partially external, is a dropsonde dispensing magazine bucket which receives a four position dropsonde magazine containing a dropsonde canister loaded with a Micro-sized Air-deployed eXpendable Meteorological Sondes (MAXMS) dropsonde in any or all of the four positions. Also externally mounted to the pod is an Ultra High Frequency (UHF) antenna which is electrically connected to the high power transceiver. The pod has, on the topside, a set of connection points so positioned as to allow the pod to be securely mounted onto an M-299 Missile Launcher Rail and also has a pair of mating connectors which allow the internal electronics within the pod to connect electrically to the host aircraft's 20 Hellfire Missile to Control System.

The system is intended to;

a. deploy, on command, from a canister within the dispensing magazine, a MAXMS dropsonde designed for wind soundings.

b. receive and collect the meteorological data that has been transmitted from the sonde.

c. retransmit the data, either raw or decimated, in a Precision Airdrop System (PADS™) compatible format, to a PADS™ computer carried aboard a distant cargo aircraft.

The deployment of the MAXMS from the TMS Pod (not shown) is initiated using the TMS Pod host aircraft's 20 AGM-114 Hellfire Interface system. The Pod dropsonde dispensing magazine (not shown) contains a plurality of dropsondes 30, which when deployed detect meteorological data as they fall through the atmosphere and transmit that data into free space. The Pod transceiver receives the data and transfers the data to the pod CCU computing device. The CCU assesses the data for validity and stores the data on an internal digital storage device. The CCU then re-transmits the data into free-space via the high power transmit section of the transceiver using a frequency contained within the 400-406 MHz meteorological band, the intended recipient of the data being a distant aircraft 10 approaching into the area from which the sounding data was measured.

There are several different styles of Remotely Piloted Aircraft (RPA) 20 in use today. They all have different carrying capabilities. During operations in Iraq and Afghanistan, RPAs are flown by aircrews located in centers on certain military bases, or at mobile remote control centers. This is accomplished through the use of signals between the RPA, a satellite, and the RPA remote control center. The remote aircrew controls the heading of the vehicle through the use of signals between the remote control center and the satellite, which is then relayed to the RPA 30 by signals between the RPA and the satellite. In addition to flight control of the RPA 30, the aircrew can also command the RPA's weapon, and sensor systems.

In the case of the present invention in particular, the crew is able to command the AGM-114 Hellfire missile system and receive status updates from the AGM-114 Missile system through the use of the satellite signals in the same manner as the flight control signals. During the scenario in which a TMS Pod is installed into an AGM 144 position, the AGM-114 control signals are received by the TMS Pod CCU and translated into signals used internally for the function of the TMS Pod. For example, if the RPA aircrew were to issue a command to launch a Hellfire missile, the TMS Pod would receive that signal and translate it into the signal required to deploy a dropsonde.

The MAXMS dropsonde 30, is a fully PADS™ compatible dropsonde designed for RPA operations. The dropsonde 30 is programmed to obtain a GPS fix on the ground prior to launch, The dropsonde 30 is equipped with a battery backup which allows the dropsonde 30 to store the GPS data, enabling it to get a fix almost instantaneously if launched within 4 hours of acquiring an initial GPS fix. Outside that window, the MAXMS will typically get a GPS fix within 45 seconds after launch. The MAXMS dropsonde 30 measures wind speed, wind direction, pressure, temperature and humidity while descending. The MAXMS transmits the data in real time on a channel within the 400-406 MHz meteorological band into free space. The receiver section of the transceiver located in the TMS Pod via the antenna mounted on the pod will receive the signals from the MAXMS dropsonde 30.

The dropsonde 30 release sequence would be initiated by the RPA 20 remote aircrew manually via the Hellfire control signals interface. The aircrew will issue a launch command via the Hellfire control interface and the signal will travel along the Hellfire control lines to the CCU in the TMS Pod. The CCU will receive the signal and apply a voltage to an explosive squib causing the squib to ignite. The explosion of the squib will produce enough force to propel the MAXMS dropsonde 30 from the canister at a velocity of 167 feet per second, which has been determined through engineering and testing to be adequate to send the sonde outside of the swept area and thus prevent it from striking an RPA's 20 rear mounted propeller. The Pod could also be carried by a manned plane and the launching of the dropsonde 30 would therefore be controlled by the aircrew of that aircraft, also using the Hellfire control signals interface.

The average time of descent for a dropsonde 30 is 6 minutes from 12,000 feet. The data recorded by the CCU onboard the RPA 20 is then re-transmitted to the approaching cargo aircraft 10 and takes the same amount of time to re-transmit the data as it took to initially receive.

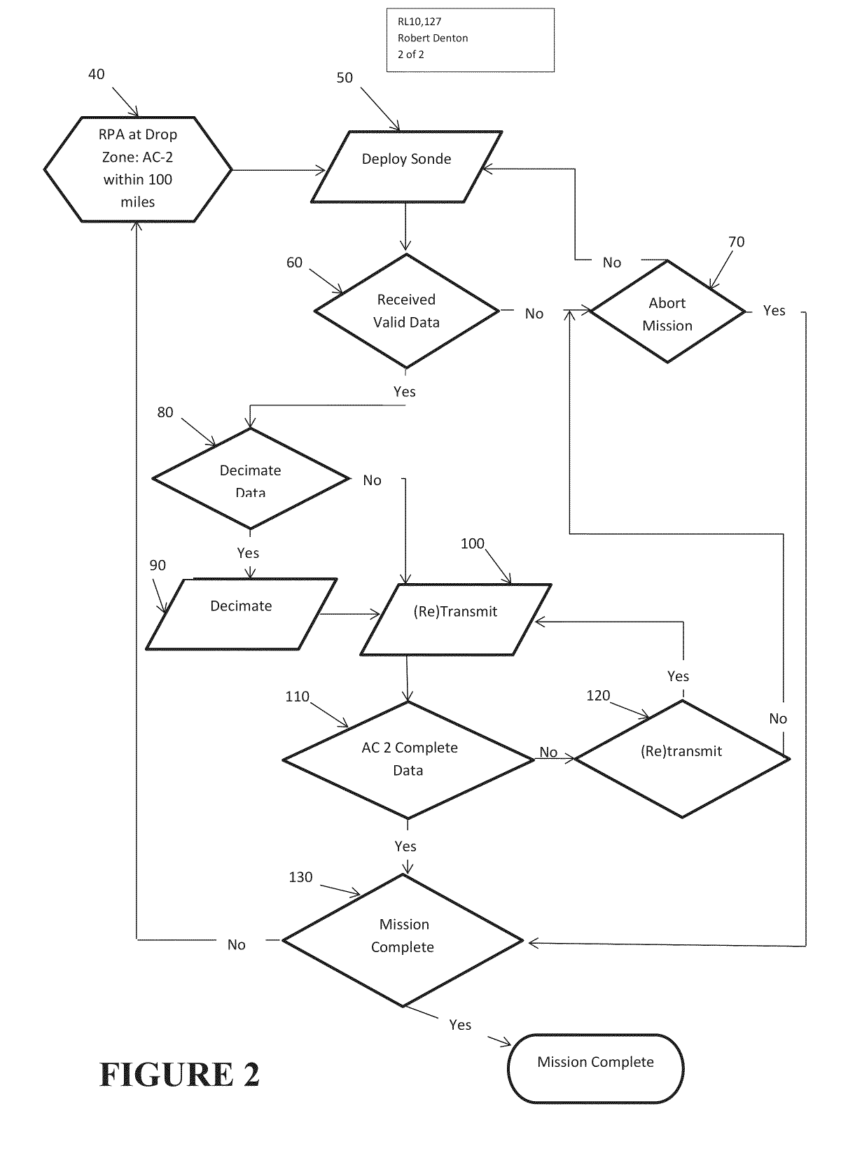

Referring to FIG. 2, since the data collected also includes temperature, pressure and humidity which is not currently used by the PADS computer, the CCU onboard the RPA 20 (see FIG. 1) has the option of decimation of the data 90 and re-transmitting 100 only the wind vector data, thus reducing the time to re-retransmit by 75%. Also, since the dropsonde 30 (see FIG. 1) collects data at a rate 4 times greater than that needed by the PADS computer, further decimation 90 is available by a method of developing a dataset which is derived by taking the average of every group of four data readings combining them into a single reading thus reducing time to re-transmit by a total of 95%, resulting in a 6 minute data set being reduced to a re-transmit time of approximately 23 seconds. The decimated data can also be replayed in a loop providing redundancy of data reception at the approaching aircraft 10 (see FIG. 1), however the PADS computer will in its process of populating its database ignore the redundant data and only process the packets containing data that it hasn't already received thereby filling in any gaps in the database that may have occurred due to loss of signal or other factors.

During an airdrop operation coordination will be made between the dropsonde aircrew and the aircrew aboard the cargo aircraft 10 (see FIG. 1). When the cargo aircraft 10 (see FIG. 1) is within 100 nm of the drop zone the, RPA aircrew will position the RPA aircraft 20 (see FIG. 1), and initiate a dropsonde drop 40 over the drop zone. When the dropsonde(s) 30 (see FIG. 1) are released 50 over an area, they will obtain a GPS fix, sense the weather conditions and transmit the data into free space where it will be received by the Pod mounted to the dropsonde aircraft 20 (see FIG. 1). The CCU will receive the data, check the data for validity 60 and then send a valid/invalid indication to the

RPA aircrew and if valid, the aircrew can then decide to instruct the TMS Pod to decimate or not decimate the data 80. If the decision is made to decimate a signal is sent over the control circuitry which instructs the CCU to decimate and by what degree the data. The CCU will then decimate 90 and store a decimated data file, and leave the original data file intact for future use. If the decision is made 80 to not decimate the data, or the decimation of the data is complete, then the aircrew can signal the TMS Pod to begin retransmitting 100 the desired data file via the high power transceiver into free space for reception by the approaching cargo aircraft 10 (see FIG. 1). The approaching cargo aircraft 10 (see FIG. 1) will receive the data via the PADS receiver and transfer the data to the PADS computer which will analyze 110 the data file for completeness, validity, and the ability to use the file to compute an update to the Calculated Air Release Point (CARP). In the event the data file is not complete the PADS operator will inform the TMS aircrew to again retransmit the data 120. The PADS computer will, in its process of populating its database, ignore the redundant data received during a retransmission 120 and only process the packets containing data that it hasn't already received, thereby filling in any gaps in the database that may have occurred due to loss of signal or other factors. The process of retransmission can be repeated several times until the PADS computer determines that the data is complete and valid 110. The cargo aircraft 10 (see FIG. 1) aircrew will then adjust their airspeed and heading according to the new CARP and release the bundle at the proper time and space as indicated by the PADS computer, after which the decision is made whether the mission for the TMS Pod is complete 130, if so then the aircraft return to their respective bases or continue on their next mission as needed.

In the event after several retransmission 120 attempts the data is still not received by the cargo aircraft, the aircrews can make the decision 900 to not retransmit the file again and further decide 70 to abort the mission completely or to start the process over with a new data file developed by deploying 50 another dropsonde 30 (see FIG. 1).

In the event that data is not received by the Pod or the Pod CCU determines the data is invalid 60, the aircrew of the dropsonde RPA aircraft 20 (see FIG. 1) can decide to abort the mission completely 70 or to start the process over with a new data file developed by deploying another dropsonde 50, thus repeating the entire sequence.

Since the data gathered by the dropsondes 30 (see FIG. 1) will also include temperature, pressure and humidity, this data can also be used and since this onboard system is capable of storing the information gathered by the dropsondes 30 (see FIG. 1) in a database the data could be downloaded at the end of the mission to the various weather communities for inclusion in their weather datasets.

The foregoing description of a preferred embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated.

What is claimed is:

1. A system for providing accurate airdrop missions, comprising
a cargo aircraft;
said cargo aircraft further comprising
a first radio frequency transceiver and a first computer having a computer software program therein;
a dropsonde aircraft;
said dropsonde aircraft further comprising
a plurality of dropsondes; and
a dropsonde pod having a second radio frequency transceiver
and a second computer having a computer program therein;
wherein said dropsondes each further comprise
a means for deriving atmospheric condition and geolocation data; and
a radio frequency transmitter; and
wherein each of said dropsondes communicates said atmospheric condition and geolocation data to said dropsonde pod; and
said dropsonde pod communicates said atmospheric condition and geolocation data to said cargo aircraft radio frequency transceiver.

2. The system of claim 1, wherein said dropsonde aircraft is a remotely piloted aircraft.

3. The system of claim 1, wherein said second computer, when instructed by said computer program, decimates said data atmospheric and geolocation data received from said dropsonde prior to communicating said data to said cargo aircraft.

4. The system of claim 3, wherein the degree to which said data is decimated, is variable.

5. The system of claim 4, wherein said first computer, when instructed by said computer program
analyzes said received data for completeness, validity, and usefulness; and
computes an updated cargo release point based on said received data.

6. The system of claim 5, wherein said cargo aircraft adjusts speed and heading based on said updated cargo release point.

7. The system of claim 6, wherein when said first computer determines that said received data is either not complete, not valid, or not useful said dropsonde pod retransmits said data upon request.

8. The system of claim 7, wherein said first computer will ignore redundant data received during said retransmission and process only data not previously received.

9. A method for conducting accurate airdrop missions, comprising the steps of positioning a first aircraft, capable of dispensing at least one dropsonde, over an airdrop site;
dispensing said dropsonde over said airdrop site;
communicating atmospheric and geolocation data from said dropsonde to said first aircraft;
processing said data in said first aircraft;
relaying said processed data from said first aircraft to a second aircraft; and
adjusting the speed and heading of said second aircraft, based on said processed data, so as to accurately deliver cargo to said airdrop site.

10. The method of claim 9, wherein said step of processing said data further comprises the step of decimating said data to a variable degree.

11. The method of claim 9 wherein said first aircraft is remotely piloted.

12. The method of claim 10, wherein said step of decimating said data to a variable degree further comprises the step of taking the average of a predetermined number of data readings and combining them into a single reading.
